(19) United States
(12) Patent Application Publication
(10) Pub. No.: US 2017/0032768 A1
(43) Pub. Date: Feb. 2, 2017

(54) WRAPAROUND BRIDGES OR TAILPIECES FOR STRINGED INSTRUMENTS

(71) Applicant: David Dunwoodie, Delta (CA)

(72) Inventor: David Dunwoodie, Delta (CA)

(21) Appl. No.: 15/225,036

(22) Filed: Aug. 1, 2016

Related U.S. Application Data
(60) Provisional application No. 62/199,850, filed on Jul. 31, 2015.

(51) Int. Cl. G10D 3/12; G10D 3/04

(52) U.S. Cl. CPC G10D 3/12; G10D 3/04

(57) ABSTRACT

A wraparound bridge or tailpiece for a stringed musical instrument such as guitar, banjo, and the like, comprising an elongate body having top and bottom surfaces, and front and back edges, and a mounting means for mounting to the instrument such that the bottom surface faces the instrument and the front edge faces the neck of the instrument, and a plurality of string channels defined in the bottom surface, each string channel extending from the front edge toward the back edge and including a narrow portion open to the bottom surface to receive a string and a wider front cavity open on the front edge to receive and capture the ball end of the string. Hence the end of a string with the ball end may be slid underneath the body in a fore direction and once the ball end clears the front the string may be moved upwards until it is received within the string channel, and then drawn rearwards until the ball end abuts the narrow portion of the string channel.

### BACKGROUND OF THE INVENTION

Field of Invention

The present invention relates generally to bridges and tailpieces for stringed instruments, and more particularly to wraparound bridges or tailpieces for guitars and the like.

Description of Related Art

Some stringed instruments, such as some electric guitars, use a style of bridge and tailpiece in which each is connected to the instrument's body via two threaded bridge or tailpiece posts that are screwed or secured directly into the top of the stringed instrument body. In the case of the bridge, it rests on two knurled nuts or adjustment wheels that allow for the height of the bridge to be adjusted. In the case of the tailpiece, slots at each end of the tailpiece rest within a circumferential groove on the tailpiece posts. A style of bridges known in the industry as “wraparound” combines the function of the tailpiece for securing an end of each string and the bridge for supporting the string into one structure in which each string is fed backwards through a hole in the body of the bridge and is wrapped around the back and top surfaces of the bridge and over a saddle. The sound qualities produced by using a wraparound bridge configuration may be preferred by some musicians or in certain circumstances.

A disadvantage of some prior art wraparound bridges is that they are often mounted close to the instrument body, leaving little clearance between the body and the bottom of the bridge, which can make the process of removing and replacing strings on the bridge a bit cumbersome.

### SUMMARY OF THE INVENTION

The above shortcomings may be addressed by providing, in accordance with one aspect of the invention, an improved wraparound bridge for securing to a stringed instrument, such as a guitar, banjo, and the like. In some aspects, the present invention provides a wraparound bridge for a stringed musical instrument with a neck and body and for use with strings having an enlarged terminal portion, commonly referred to as the ball end of the string, the wraparound bridge comprising: an elongate body having a top surface, a bottom surface, a front edge and a back edge, and a mounting means by which the body may be mounted on a stringed musical instrument such that the bottom surface faces the body of the instrument and the front edge faces the neck of the instrument; and a plurality of string channels defined in the bottom surface, each string channel extending from the front edge toward the back edge and including a narrow portion open to the bottom surface to receive a string and a wider front cavity open on the front edge to receive and capture the terminal portion of the string, thereby the end of a string with the terminal portion may be slid underneath the body in a fore direction and once the terminal portion clears the front edge the string may be moved upwards until it is received within the string channel, and then it may be drawn rearwards while the terminal portion is guided into the front cavity until the terminal portion abuts the narrow portion of the string channel.

In some embodiments, the back edge and the top surface may be convex, and the back edge blends into the top surface.

In some embodiments, the mounting means may comprise vertical alignment voids at each end of the body and extending from the top surface to the bottom surface for mounting the body to corresponding posts provided on the body of the instrument.

In some embodiments, a plurality of fore-aft string grooves may be provided in the top surface for locating the strings as they pass over the top surface.

In some embodiments of a wraparound bridge, a plurality saddles may be included mounted on the top surface adjacent the front edge to support the strings. In some embodiments, each saddle may be independently adjustable in a fore aft direction. In some embodiments, each saddle may be independently adjustable in height.

In some embodiments of a wraparound bridge, a plurality of saddle mounts may be included on the top surface adjacent the front edge each saddle mount being adapted to connect to a removable saddle. In some embodiments, each saddle mount may be independently adjustable in a fore aft direction. In some embodiments, each saddle mount may be independently adjustable in height.

In accordance with another aspect of the invention is provided a tailpiece for a stringed musical instrument with a neck and body and for use with strings having an enlarged terminal portion, commonly referred to as the ball end of the string, the tailpiece comprising: an elongate body having a top surface, a bottom surface, a front edge and a back edge, and a mounting means by which the body may be mounted on a stringed musical instrument such that the bottom surface faces the body of the instrument and the front edge faces the neck of the instrument; and a plurality of string channels defined in the bottom surface, each string channel extending from the front edge toward the back edge and including a narrow portion open to the bottom surface to receive a string and a wider front cavity open on the front edge to receive and capture the terminal portion of the string, thereby the end of a string with the terminal portion may be slid underneath the body in a fore direction and once the terminal portion clears the front edge the string may be moved upwards until it is received within the string channel, and then it may be drawn rearwards while the terminal portion is guided into the front cavity until the terminal portion abuts the narrow portion of the string channel. In some embodiments, the back edge and the top surface may be convex, and the back edge blends into the top surface. In some embodiments, the mounting means may comprise vertical alignment voids at each end of the body and extending from the top surface to the bottom surface for mounting the body to corresponding posts provided on the body of the instrument. In some embodiments, a plurality of fore-aft string grooves may be provided in the top surface for locating the strings as they pass over the top surface.

Other aspects and features of the present invention will become apparent to those of ordinary skill in the art upon review of the following description of embodiments of the invention in conjunction with the accompanying figures and claims.

### BRIEF DESCRIPTION OF THE DRAWINGS

An exemplary embodiment of the present invention is illustrated by way of example in the accompanying drawings in which like reference numbers indicate the same or similar elements and in which:

FIG. 1 a perspective view from the top left rear of a conventional wraparound style bridge known of the prior art;

FIG. 2 a perspective view from the top rear of the conventional wraparound style bridge of FIG. 1;

FIG. 3 a perspective view from the top front of another conventional wraparound style bridge mounted on a guitar body;

FIG. 4 a perspective view from the top right rear of a wraparound bridge according to an embodiment of the present invention;

FIG. 5 a perspective view from the bottom left rear of the wraparound bridge of FIG. 4;

FIG. 6 a bottom plan view of the wraparound bridge of FIG. 4;

FIG. 7 a front elevation view of the wraparound bridge of FIG. 4;

FIG. 8 a top plan view of the wraparound bridge of FIG. 4;

FIG. 9 a rear elevation view of the wraparound bridge of FIG. 4; and

FIG. 10 a cross section view of the wraparound bridge of FIG. 4 along plane A-A.

### DETAILED DESCRIPTION

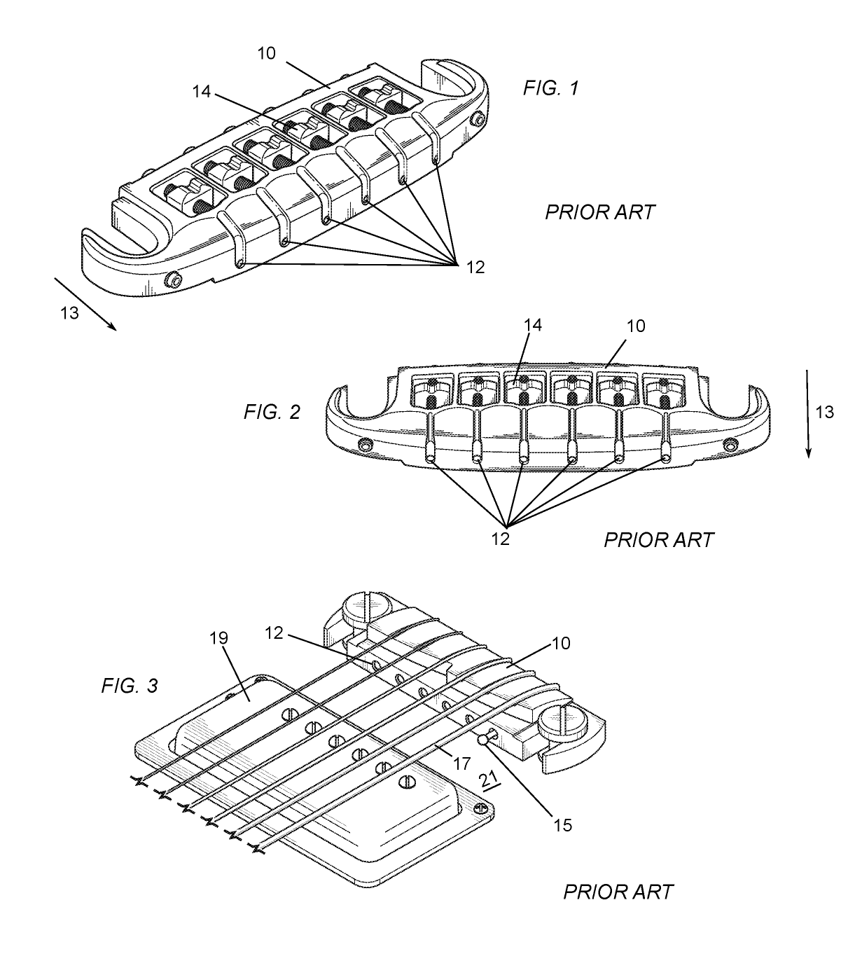

FIGS. 1-3 show examples of wraparound guitar bridges 10 of the prior art. The bridge 10 includes a plurality of holes 12 extending through the bridge body in a fore-aft direction relative to the guitar, and each string is threaded through a hole 12 in an aft direction 13 such that the terminal expanded end or ball end 15 of the string is captured by the bridge body to prevent slippage of the end of the string through the hole. Each string is then wound upward and forward over the back and upper surfaces of the bridge, and then over a saddle 14 and onward to the neck of the guitar. The strings 17 pass over the bridge 10, and in the case of an electric stringed instrument or guitar, the strings will also pass over one or more pickups 19 and then pass over the neck of the instrument and over a nut to the tuning pegs or machine heads. A disadvantage of such prior art wraparound bridges is that they are often mounted close to the instrument body 21, leaving little clearance between the body of the instrument and the bottom of the bridge, which can make the process of removing and replacing strings on the bridge a bit cumbersome. Another disadvantage of some prior art wraparound bridges is that the front of the bridge is mounted closely to the guitar pickup or the pickup housing, making it very difficult to install the string, and even more difficult to remove the string if the string breaks, leaving the string ball anchor or ball end 15 stuck in the hole 12 of the bridge 10, with little room for a user's fingers or tools to maneuver to remove ball end fragment.

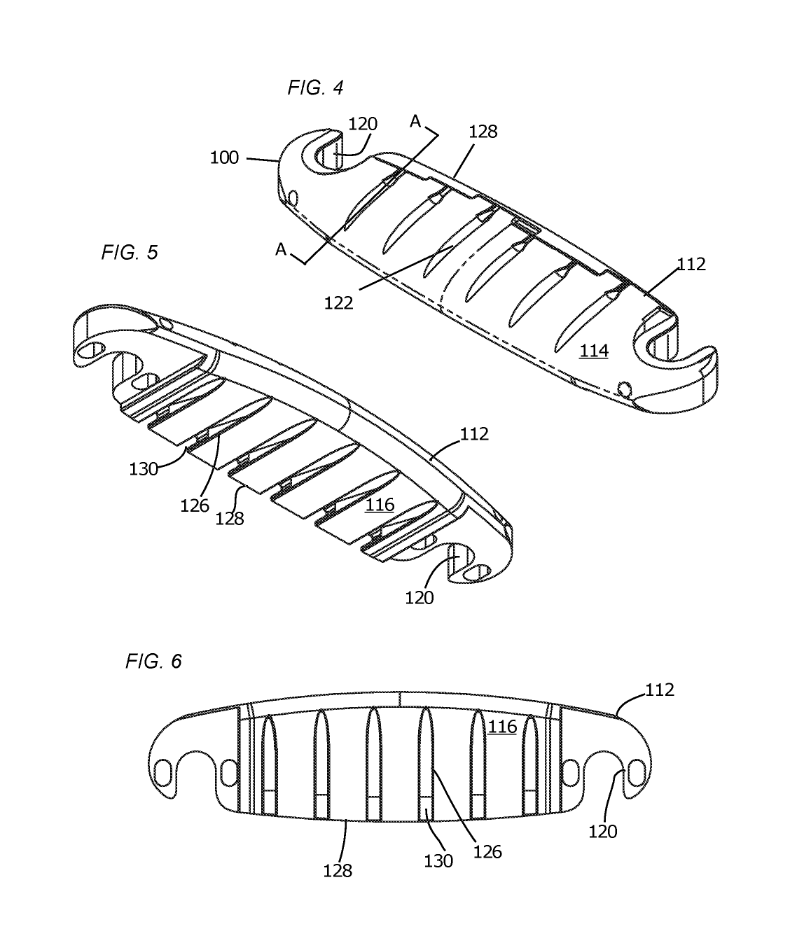

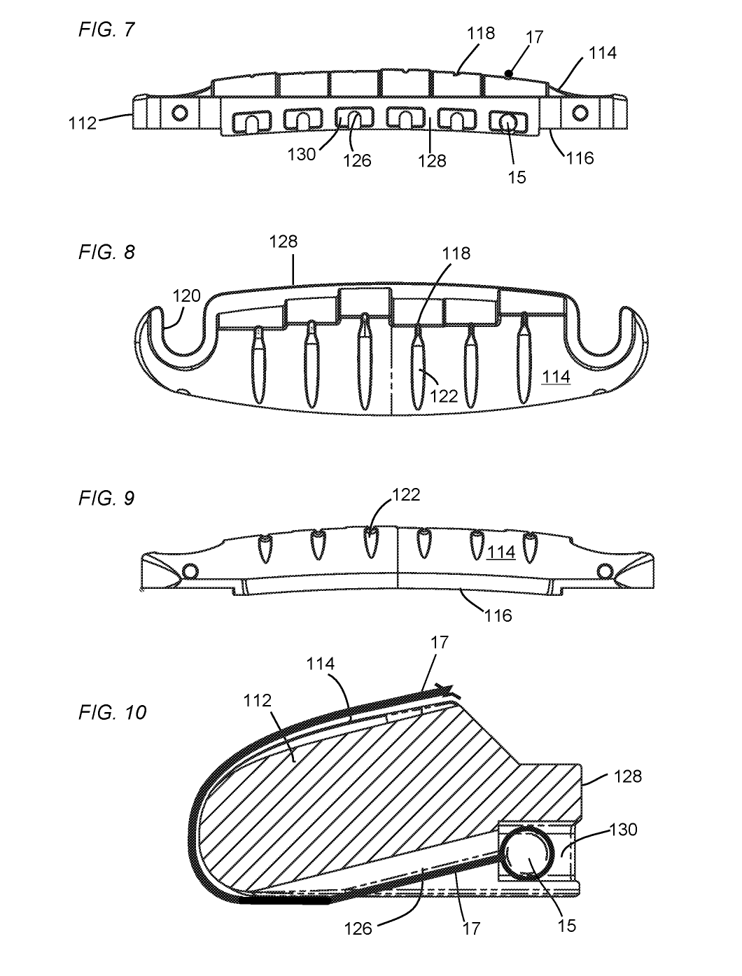

Referring to FIGS. 4-10, a wraparound bridge in accordance with an embodiment of the present invention is shown for use on a guitar, as an example. The wraparound bridge 100 comprises an elongate body or base piece 112 that is typically formed of standard metal, such as steel or brass. A top surface 114 is generally curved (convex), while a bottom surface 116 is generally flat. Alternatively, the top and bottom surfaces 114 and 116 may consist of other shapes. In the illustrated embodiment, saddles 118 are formed or mounted on the top surface 114 for supporting the strings of the instrument. In other embodiments, the saddles may be adjustable saddles mounted on saddle mounts or in channels formed or machined into the top surface 114, and may have associated hardware provided as is known in the art. Vertically through each end of the base piece 112 are vertical alignment voids such as holes 120 extending from the top surface 114 to the bottom surface 116 for connecting the bridge to corresponding posts provided in the body of the instrument. Also provided in the illustrated embodiment is a plurality of fore-aft string grooves 122 for locating the strings as they pass over the top surface 114 of the bridge 100. In some embodiments, the string grooves 122 may be omitted, or they may vary in shape, depth, length or configuration.

Referring particularly to FIGS. 5, 6 and 10, bridge 100 includes a plurality of fore-aft channels 126 on the bottom surface 116 of the base piece 112. A narrow portion of each channel 126 extends to the front edge or face 128 of the bridge 100 and includes a wider front cavity such as expanded opening 130 on the front face 128. The narrow portion of channels 126 are each adapted to receive a string therein, and the expanded openings 130 are configured to receive and capture the expanded terminal portion or ball end of the string. The channels 126 are open to the environment on the bottom surface 116, and the opening 130 is open to the environment on the front face 128 of the bridge 100.

Accordingly, the terminal end of a string, with its expanded ball end, may be slid underneath the bridge 100 (with the bridge mounted on an instrument) in a fore direction, and once the ball end of the string passes the front face 128 of the bridge, the string may be moved upwards until it is received within a channel 126. Then the string may be drawn rearwards while the ball end of the string is guided into the opening 130 of said channel 126 until the ball end engages the shoulder defined by the narrower channel 126. Thereby, the ball end of the string is captured within the opening 130 and the adjacent portion of the string is located within the channel 126. The remainder of the string may then be (i) urged upward and forward over the top surface 114 of the base piece 112, (ii) located within the string grooves 122 and over the corresponding saddle 118, and (iii) eventually fastened to the tuning mechanism of the instrument. The removal of a string is also simplified in that once tension on the string is removed by loosening of the tuning machine, the terminal end of the string can be slid forward until the ball end clears the opening 130, and then the end of the string can be urged out of the channel 126 and thereafter withdrawn rearward of the bridge 100.

A wraparound tailpiece in accordance with the present invention may be very similar in structure as in the described wraparound bridge except that saddles or saddle mounts would be omitted since the saddles on instruments configured with a separate tailpiece would be located on the bridge and the function of the tailpiece is simply to attach the ends of the strings to the instrument.

The present invention obviates the need to thread each string through a hole (i.e. holes 12) such as in the wraparound bridges of the prior art, thereby simplifying the task of restringing a musical instrument.

While the above description and illustrations constitute preferred or alternate embodiments of the present invention, it will be appreciated that numerous variations may be made without departing from the scope of the invention. Thus, the embodiments described and illustrated herein should not be considered to limit the invention as construed in accordance with the accompanying claims.

1. A wraparound bridge for a stringed musical instrument for use with strings having an enlarged terminal portion, the wraparound bridge comprising: an elongate body having a top surface, a bottom surface, a front edge and a back edge, and a mounting means by which the body may be mounted on a stringed musical instrument such that the bottom surface faces the instrument and the front edge faces a neck of the instrument; and a plurality of string channels defined in the bottom surface, each string channel extending from the front edge toward the back edge and including a narrow portion open to the bottom surface to receive a string and a wider front cavity open on the front edge to receive and capture the terminal portion of the string, thereby the end of a string with the terminal portion may be slid underneath the body in a fore direction and once the terminal portion clears the front edge the string may be moved upwards until it is received within the string channel, and then it may be drawn rearwards while the terminal portion is guided into the front cavity until the terminal portion abuts the narrow portion of the string channel.

2. The apparatus as claimed in claim 1, wherein the back edge and the top surface are convex, and the back edge blends into the top surface.

3. The apparatus as claimed in claim 2, further including a plurality of fore-aft string grooves in the top surface for locating the strings as they pass over the top surface.

4. The apparatus as claimed in claim 1, further including a plurality of fore-aft string grooves in the top surface for locating the strings as they pass over the top surface.

5. The apparatus as claimed in claim 1, further including a plurality saddles mounted on the top surface adjacent the front edge to support the strings.

6. The apparatus as claimed in claim 5, wherein each saddle is independently adjustable in a fore aft direction.

7. The apparatus as claimed in claim 6, wherein each saddle is independently adjustable in height.

8. The apparatus as claimed in claim 1, wherein the mounting means comprises vertical alignment voids at each end of the body and extending from the top surface to the bottom surface for mounting the body to corresponding posts provided on the body of the instrument.

9. The apparatus as claimed in claim 1, further including a plurality of saddle mounts on the top surface adjacent the front edge each saddle mount being adapted to connect to a removable saddle.

10. The apparatus as claimed in claim 9, wherein each saddle mount is independently adjustable in a fore aft direction.

11. The apparatus as claimed in claim 10, wherein each saddle mount is independently adjustable in height.

12. A tailpiece for a stringed musical instrument for use with strings having an enlarged terminal portion, the tailpiece comprising: an elongate body having a top surface, a bottom surface, a front edge and a back edge, and a mounting means by which the body may be mounted on a stringed musical instrument such that the bottom surface faces the instrument and the front edge faces a neck of the instrument; and a plurality of string channels defined in the bottom surface, each string channel extending from the front edge toward the back edge and including a narrow portion open to the bottom surface to receive a string and a wider front cavity open on the front edge to receive and capture the terminal portion of the string, thereby the end of a string with the terminal portion may be slid underneath the body in a fore direction and once the terminal portion clears the front edge the string may be moved upwards until it is received within the string channel, and then it may be drawn rearwards while the terminal portion is guided into the front cavity until the terminal portion abuts the narrow portion of the string channel.

13. The apparatus as claimed in claim 12, wherein the back edge and the top surface are convex, and the back edge blends into the top surface.

14. The apparatus as claimed in claim 13, further including a plurality of fore-aft string grooves in the top surface for locating the strings as they pass over the top surface.

15. The apparatus as claimed in claim 12, wherein the mounting means comprises vertical alignment voids at each end of the body and extending from the top surface to the bottom surface for mounting the body to corresponding posts provided on the body of the instrument.
